(19) United States
(12) Patent Application Publication
(10) Pub. No.: US 2015/0248635 A1
(43) Pub. Date: Sep. 3, 2015

(54) METHOD, SYSTEM AND SOFTWARE PRODUCT FOR MANAGING PEOPLE, GOODS AND SERVICES USING AUTOMATIC IDENTIFICATION TECHNOLOGY

(71) Applicant: WHITE LION S.A., Lima (PE)

(72) Inventor: Jorge Salcedo, Lima (PE)

(21) Appl. No.: 14/422,983

(22) PCT Filed: Aug. 22, 2013
(86) PCT No.: PCT/IB13/56820

§ 371 Date: Feb. 20, 2015

Related U.S. Application Data
(60) Provisional application No. 61/692,126, filed on Aug. 22, 2012.

(51) Int. Cl. G06Q 10/08; G06K 7/10; G06Q 50/02

(52) U.S. Cl. CPC G06Q 10/087; G06Q 50/02; G06K 7/10366

(57) ABSTRACT

The computer implemented method and computer program product provided in accordance with the present invention allows a user-company to consign and track corporate personal protective equipment, or “PPE,” assets to specific employees, suppliers, contractors, visitors, guests and other authorized persons, as well as to control, manage and validate the expiration period of PPE, and the entry and exit of PPE at any job sites and/or industrial and mining operations. The computer implemented method and computer program product use radio frequency identification, or “RFID,” technology via fixed control or mobile/portable control methodologies.

This Application claims the benefit of U.S. Provisional Application No. 61/692,126, filed Aug. 22, 2012.

### FIELD OF THE INVENTION

The present invention relates generally to the field of computers, peripheral computer devices and software methods that enable user interaction with computers, particularly of the type where data and information is collected and documented via batch and wireless technology using both fixed and/or mobile/portable equipment. The present invention also relates generally to web-based (i.e. utilized by means of the virtual community that exists on the “Internet” or within the “World Wide Web,” or “www”) methods and systems, as well as non-web-based methods and systems, for acquiring, storing, transmitting, processing, retrieving and displaying information and data.

More particularly, the present invention relates to a method, system and software product for data collection, data storage, data transmitting, data analysis, and data reporting of the type that is used to facilitate improved asset utilization and process optimization in a variety of settings. Specifically, the present invention provides a multi-industry technological solution for managing people, goods and services using an automatic identification technology with fixed and mobile/portable equipment. It also substantially relates to such a method, system and software product that utilizes radio frequency identification technology, which is known in the art of wireless communication devices and in the art of electronic identification methods, for use in virtually any industrial or production setting.

### BACKGROUND OF THE INVENTION

In the area of automatic electronic identification technology and data acquisition technology, the use of wireless communication devices is well known. Radio frequency identification (RFID) technology, in particular, is well known in the art of wireless communication devices and in the art of electronic identification methods. RFID technology relies on the storage and remote retrieval of data by means of one or more transmission or transponder devices that are frequently called RFID “tags.” An RFID tag is a small electronic device that can be attached to or incorporated within a physical item or object for a number of different purposes. RFID tags contain micro-circuitry and antennas that enable them to receive and respond to radio frequency queries from an RFID transceiver. Passive tags require no internal power source, whereas active tags typically require a power source.

Current technology, known to this inventor, includes for example, the use of RFID tags by at least one government office where RFID tags have been implanted in various staff members to control access to secure data rooms. Accordingly, it will be seen that RFID technology is mature and capable of storing the granularity of information that is required for the system and method of the present invention. It is to be understood, however, that wireless communication devices, in both fixed and mobile/portable equipment may include other types of automatic electronic identification and communication technologies other than RFID. For example, certain wireless and cellular phone technologies may be combined with a wireless network and include devices such as pagers, cell phones, smart phones, Blackberry® devices (Blackberry is a registered trademark of Research in Motion Ltd.), personal digital assistants (PDA), tablet computers, iPad® devices (iPad is a registered trademark of Apple Inc.), Bluetooth®® headsets (Bluetooth is a registered trademark of Bluetooth Sig, Inc.), desktop personal computers (PCs), laptop computers, kiosks, slate computers and dumb terminals. Each of these technologies, and its ability to operate in the context of the method and system of the present invention, is proven to be effective wireless technology. These technologies are mature and capable of storing, processing and providing reporting at the level of granularity required in accordance with the present invention. It is to be understood, however, that such other wireless communication devices and other wireless communication methodologies are included within the scope of the present invention. All such technologies are collectively referred to in this application as “RFID technology” or simply “RFID.”

In the view of this inventor, the security of any company in any industry begins with the correct identification of its employees. In the same way, counting on certain efficient control mechanisms of time and attendance, entrance and accesses, provides management with processes that become a powerful tool to organize people, their capital contribution and job materials, thereby generating high productivity in the business and providing a secure place to work. To this end, this inventor believes that there is a need, in the field of data collection, to utilize RFID technology in settings where the collection of data is directed towards a use in any number of industries, including, but not limited to, the mining and natural resource industries, for the security and the integrity of employees (sabotage, terrorism and the like), the fulfillment of legal/regulatory requirements (such as time and attendance control according to applicable laws), the prevention of losses (mess hall and camp control) and serve as a data source to contribute to the productivity of operations (scan and go). In the scope of the present invention, it is also desirable that the method and system employed guarantee a continuous operation of the method and system with minimum response time for different controls, without interruptions for data and energy network cuts, with the best available after sale support, prevention, error corrections and additionally with its nature of a First Read Rate. It is also desirable that the method and system be modularized such that various administrative and operative modules can be used.

More specifically, and in the view of this inventor, what is needed is a method, system and software product that manages people, goods and services by providing “modules” that address one or more of the following functionalities:
General Management and Administration Module
Candidate Management and Control Module
Identification Management and Control Module
Employee and Vehicle Access Management and Control Module
Induction and Training Management and Control Module
Time and Attendance Management and Control Module
Mess Hall Management and Control Module
Camp Management and Control Module
Visits Management and Control Module
Insurance Management and Control Module
Fuel Management and Control Module
Transport Management and Control Module and
Personal Protective Equipment (or “PPE”) Management and Control Module

Additionally, certain administrative and operative modules are created for the present invention and which address the following:
General Data Management and Maintenance Module
Security Module
Auditing Module and
Operational Continuity Module

Lastly, the training of personnel relative to such modules would include the following:
Enlisting Users and Data Base for Identification Module
Administrative Users for Identification Module
Users of Fixed and Portable/Mobile Terminals for Access Control
Administrative Users of Access Control
Users of Fixed and Portable/Mobile Terminals for Attendance Control
Administrative Users of Attendance Control and
Administrative Users of Visiting Module

### SUMMARY OF THE INVENTION

In accordance with the foregoing, this inventor has devised a method, system and software product in accordance with the present invention where certain modules are provided, as outlined above, for use with virtually any industry. The present invention guarantees continuous operation of the implemented and underlying solution with a minimum response time for different controls, when data interruptions and power network outages occur. In accordance with the present invention, the modules of the type mentioned above are used with particular emphasis on PPE Management and Control. The foregoing and other features of the method, system and software product of the present invention shall become apparent from the detailed description that follows.

### BRIEF DESCRIPTION OF THE DRAWINGS

FIG. 1 is a schematic diagram illustrating the features and functionality of the “Candidate Management and Control” Module of the present invention.

FIG. 2 is a schematic diagram illustrating the features and functionality of the “Identification Management and Control” Module of the present invention.

FIG. 3 is a schematic diagram illustrating the features and functionality of the “Fixed Access Control and Management” Module of the present invention.

FIG. 4 is a schematic diagram illustrating the features and functionality of the “Mobile Access Control and Management” Module of the present invention.

FIG. 5 is a schematic diagram illustrating the features and functionality of the “Time and Attendance Management and Control” Module of the present invention.

FIG. 6 is a schematic diagram illustrating the features and functionality of the “Mess Hall Management and Control” Module of the present invention.

FIG. 7 is a schematic diagram illustrating the features and functionality of the “Camp Management and Control” Module of the present invention.

FIG. 8 is a schematic diagram illustrating the features and functionality of the “Visits Management and Control” Module of the present invention.

FIG. 9 is a schematic diagram illustrating the features and functionality of the “Transport Management and Control” Module of the present invention.

FIG. 10 is a schematic diagram illustrating the features and functionality of the

“PPE Management and Control” Module using fixed terminals of the present invention.

FIG. 11 is a schematic diagram illustrating the features and functionality of the “PPE Management and Control” Module using mobile/portable device of the present invention.

### DETAILED DESCRIPTION

As a prefatory statement, it is to be understood that the method and system for managing people, goods and services, using an automatic identification technology with fixed and mobile/portable equipment of the present invention, assumes usage of a specific computer program product comprising a plurality of modules, each of which is used within an electronic data input, data processing, data storage, data transmitting and data output environment, the computer program product further comprising certain system building block “components.” Those components are data structures, data processors and interfaces, and each component is a functional element. The data structures are places to organize and store data. The data processors are used to manipulate data by performing processes or applying algorithms to the data.

Any interface used connects the data structures and the data processors to the outside world, or to other data structures and data processors, including the virtual internet-based community that exists within the “World Wide Web” or “www.” The program includes source code, which is a list of instructions, written in a selected computer language, and then converted into computer machine language, which language the computer uses to build the software “machine” described by the instructions.

The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention.

It should also be understood that the method and system of the present invention is made possible by virtue of the existence of the Internet and RFID technology as mentioned earlier in this detailed description.

### The “General Management and Administration” Module

As mentioned earlier, one module in accordance with the present invention is the “General Management and Administration” Module. This Module comprises general data administration functionality that registers and updates data to supplement and place parameters on the core functionalities of the system. Those functionalities may be summarized as follows:
People Registry (Employees and Contractors)
Vehicle Registry
Company Registry (multiple companies)
Departments or administrative areas Registry
Cost Centers Registry
Creating and Allocating Additional Data such as people qualifications, blood type, hometown, etc.
Vehicle Type Registry
Driver License Types Registry
Visitors Registry
Languages Registry (multiple languages)
Currencies Registry (multiple currencies)

Handling this information allows the user, or “user-company,” to configure the system and set different parameters for multiple companies, languages and currencies. That is, this is a system that is scalable in data, information and services. Updating this basic data can be done automatically by the system through an enterprise resource planning (“ERP”) program such as SAP® (SAP is a registered trademark of SAP AG), Ellipse™, or others.

The system security for this Module comprises several levels. The first level is “Data Base Security” which contemplates product security or the key supplied to the user-company. This key is unique for each user that uses the system of the present invention and is linked to certain referential data such as Name of Company, tax ID number, etc. The second level is “Modules User Security” which allows the system to handle permissions by module or sub-module. This means that the users may be restricted to the use of a specific module(s) or sub-module(s). The third level is “Users Actions Security” wherein each module may have a security per action button. This means that the user may be restricted on terms of creating, modifying and viewing data. The fourth level is “User Security by Groups” wherein each user can be assigned to a group in which the user is responsible for the data handling. That is, the group's user's issue, view and modify data, but only for that one group. To better handle security, the system of the present invention allows for the creation of profiles that can be assigned to users as per the needs and responsibilities of their jobs.

Every registry or action of the system in this Module tracks security data such as user, date and hour of modification of registry. That is, it has “system data audit” capabilities. Further, operational continuity in this Module warrants the continuous operation of the invention's system or applications, especially those that work in real time. To achieve operational continuity, both the on-line and/or off-line options may be used either jointly or separately, depending on the technical and infrastructure conditions. Both the on-line and off-line modes “capture and control” data either “on-line” and/or “off-line”—meaning that, if a device normally works on-line, validating and registering data directly from the server, and there is a sudden loss of network connectivity, for whatever reason, the device starts to work in an “off-line” mode, validating the transactions against its own database and storing them in its own memory. Once the connectivity with the server recovers, an automatic synchronization of the stored data begins and the device goes back to an “on-line” mode. Furthermore, these automated restoring and supporting applications ensure that, if 2PERSONNEL® applications stop working due to external problems, there is an “auto-restore” of programs, in real-time. In a worst case scenario a real-time warning or alarm is sent to technical support by electronic messaging such as e-mail, network message and/or short message service (SMS) such as text messaging, as a warning and thereby optimizing costs and response times.

### The “Candidate Management and Control” Module

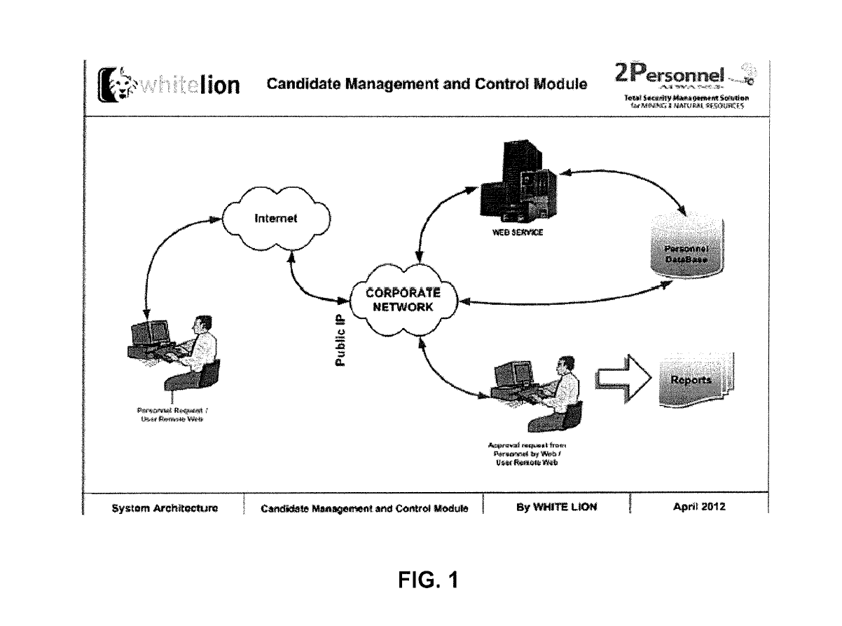

The “Candidate Management and Control” Module manages the information and prerequisites involved in the process of work entry or re-entry of persons to the user-company, be these employees or contractors. The process implies medical authorizations, contracts, insurance, required courses and training among others, which the user may configure. This action is performed electronically using a web-based or internet-based application and electronic emails. See FIG. 1, generally.

Management of this Module comprises defining the “prerequisites” for the candidate evaluation process of those persons who wish to join the company. The defined prerequisites may be date, ranges of values, compliance or non-compliance, among others. Each prerequisite may be approved, disapproved or exonerated. This Module also allows for the possibility of configuring candidate profiles. Different evaluation prerequisites for each worker profile can be configured per the company's work application process. The module also allows for the definition of different authorization profiles per prerequisites. This could include medical authorizations, authorization of contracts, training, etc. An indefinite number of authorizers can be defined for each authorization profile (n persons). The system allows for authorizers who can exonerate candidates of certain prerequisites. This module also allows users to define company work sites (geographic locations). Each location can be configured to have different candidate evaluation prerequisites for joining the company. The system allows corporate users as well as contractors to authorize work entry or re-entry of its employees. Further, the system allows for the uploading of evidential documents for each required prerequisite in the entry evaluation process. User-company or contractor staff upload these documents. The module also allows for the creation of management reports. For example, in a specific area where an employee has permission to leave the work site, within a range of specific dates, the system provides a list of personnel in each work area, who are physically present at the operational work site, as well as a listing of personnel (per area) who have not left the operational work site per their work schedule, within a range of determined dates.

Operation of this Module requires candidate prerequisites to be entered and approved via a web page. To enter this web page, the person responsible at each of the contractor companies and each authorizer enters the web page with their assigned code and password. This is initially assigned in 2PERSONNEL® and, later, it can be modified via the web page. The system provides access to this web page where responsible parties at each company register worker data such as company name, candidate name and family names, assigned work area, cost center, type of entry (new personnel or re-entry), type of document, number of document, birth date, birth place, address, number of driver's license, type of driver's license, phone numbers and other data that can be configured into the system. In this way, the people responsible for each area receives an email containing the candidate's web form data for their subsequent approval. By using a web page, different authorizers can approve each candidates form accordingly. The system can be configured to approve medical exams, required courses and/or training, authorizations, driving permits, mess hall access among others. Configuring prerequisites with a maximum approval period is possible as well. After this period expire and if it is not revised, e-mail is sent to the corresponding authorizer. Approving candidate is performed in parallel and if there is just one disapproval, the form is rejected and the candidate is unable to join the company. All those involved in the approval or rejection process are informed of the outcome with e-mail. Only the authorizer who approved, exonerated or cancelled the status of a prerequisite can be changed or exonerate it. The system registers the author and dates of each activity. 2PERSONNEL® manages candidates, so that all corresponding data and authorizations granted to the candidate can be visualized. When all approvals have been performed, the form status changes to “APPROVED.” This is useful when registering a candidate as a worker, which is a process completed in 2PERSONNEL® using the creating workers functionality. The user may import approved candidate data into the system. Upon completion of the approval process, the candidate's form is e-mailed to the corresponding managers at each company. Candidate form reports can be generated as desired or required.

As will be seen later in this detailed description, control-point compliance of entry prerequisites is verified in the “Access Management and Control” Module, which ratifies compliance and validity of each one. In this sense, and depending on the equipment being used to manage and control access (fixed or portable), the system initiates an alarm at every control point (with a visible and audible signal) when registering non-compliance of any of the prerequisites.

### The “Identification Management and Control” Module

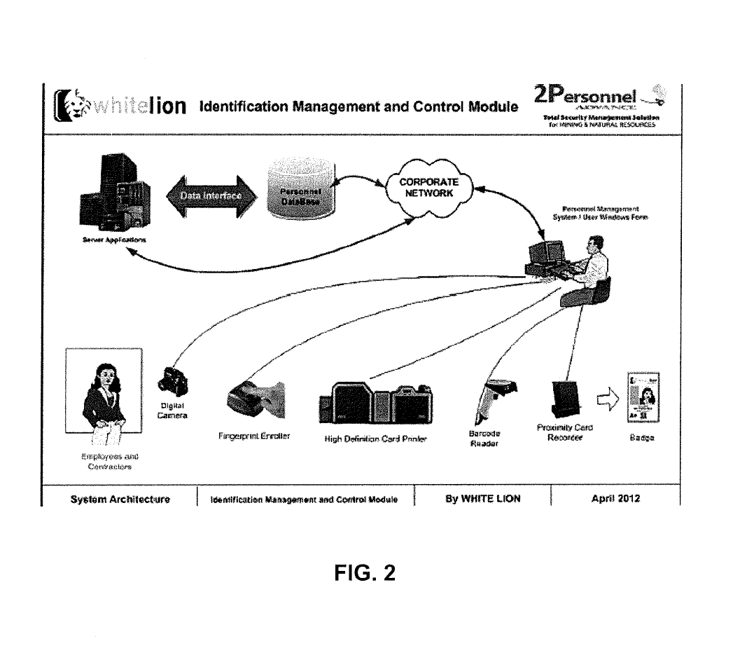

The “Identification Management and Control” Module requires that all persons having a direct and continuous relationship with the user (which is a company or “user-company” as mentioned earlier) and with its system, be duly and timely identified by a graphical, electronic and secure document. This document can be used for personnel control in other user-related (or company-related) processes that the user-company may wish to implement. This Module requires generating an “identification document,” which is a document, or “card,” that identifies personnel and can involve any number of technologies such as, but not limited to, linear barcodes, bi-dimensional barcodes, proximity cards, magnetic band cards, fingerprints, Smart Card, 125 Khz RFID, 13.56 Mhz RFID, and the like. The code that is saved in the card is a unique, system-generated code called “Photocheck Code.” This code is independent from the “Employee Code” used by the user company in its ERP system. See FIG. 2, generally.

Management within this Module refers to information and process administration during employee identification. Generally this process is carried out by a computer system working on a PC supported by a database on the user's corporate network. This Module conducts several discrete functions. The first is to identify different groups such as employees from the user-company and/or personnel from the user-company's strategic partners (such as contractors) and visitors. The system allows for a graphic interface (user screen) in which new people may be added to the groups, allowing for data modification and even deletion if the configured user profile permits. Should fingerprint identification be used, the system allows enrollment (initial registration of the fingerprints) of the employees graphically, and in a user-friendly way, within a minimum amount of time, determining even the quality of each fingerprint and choosing the most appropriate fingerprint for the purpose of identification. This process may be centralized, which means that there is an office where all enrolled personnel undergo a one-time process to register fingerprints, then these fingerprints are distributed via the network to biometric readers. Although corporate staff carries out the registration process, interfaces are available that allow for automated data updates with the company's information systems (SAP®, Ellipse™, etc.).

Likewise, all vehicles of the user-company and its strategic partners may be identified and registered. The data the system handles on vehicles such as plate number, model, color, technical revision expiration date, etc. may be printed on stickers or cards. This identification displays on stickers adhered to vehicle windshields. Also with this Module, the system allows for driver license management, that can be defined by the user according to the types of vehicles created in the system. Driver licenses grant permission to operate certain types of vehicles and to travel in specific areas defined by a user. It also allows for driver licenses to be issued on labels similar to those on vehicles. The labels may have an adhesive backing on the employee or people identification badges.

Under this Module, there is no personal identification for visitors, but generic cards are registered in the system. These cards have the same technical features as employee IDs and are exchanged for a visitor ID card for the duration of their visit. Visitors are registered the first time they visit the premises, which allows for easy location in the system for subsequent visits (recorded by ID number or any other valid identity document such as passport, driver license, etc.).

2PERSONNEL®′s cards designer functionality provides users, with graphic tools, to prepare different models of ID cards as corporate may deem necessary. To prepare the model templates for ID cards, for example, the user may include and combine data managed by the user-company such as names, surnames, positions, companies, departments, etc.

The system further allows for creating additional data per user; the system's scalability provides the possibility of including data that was not required initially, and even provides for a visual differentiation of the cards. Thus, if the need of adding marital status arises, the system can, without needing any programming, create the new marital status data and assign the field to the persons on their identification badges. For each data set created as stated above, the user may insert graphic objects on the card's design as well.

Among other things, the system of the present invention also allows the user to register important information for workers inside a mine, for example, such as expiration dates for medical examinations, insurance policies, required coursework and the like. The system can also quickly check expiration dates of medical examinations, insurance policies, contracts, etc. The system allows the user-company to record key data for vehicles operating within a mine, for example, such as expiration dates, technical inspection, date of manufacture, insurance policy expiration date, etc. The system also allows the user to quickly look at the expiration of the maturity dates of insurance, technical inspections, contracts, etc. of vehicles in the mine. Further, card issuance management reports (issued, expired, duplicated and by date ranges) can be generated as desired or required.

Operation of the Identification Management Module refers basically to updating and maintaining the data and issuance of identification badges. This has the following scope: the time frame of the identification cards' validity is assigned according to the main company's employee contracts validity; or as per the validity of the contracts with the strategic partners of the company (contractors). The validity can be extended as the above-mentioned contracts are extended. The issuance of the physical badge is carried out by the personnel system. Further, the personnel Identification Module is capable of printing and/or recording (saving) using different technologies and media such as linear barcodes, bi-dimensional barcodes, magnetic bands, proximity cards, intelligent cards and can likewise enroll fingerprints. The vehicle identification process requires a data registry such as plate number, manufacturing date, technical inspection date, etc. Once the data entry process has been completed, vehicle identification may be issued as per the model established by the user-company. Concerning fingerprints, the system of the present invention allows the user to enroll prints through a user-friendly interface. It validates the quality of the fingerprint to be able to select the best two prints that are used to validate access control processes as well as attendance control, etc. On the identification means (cards for persons) or on the vehicle control (stickers), the printed objects can have security allocated for object printing (texts or images) that are only visible through an ultra-violet light (UV), thereby increasing the difficulty in replicating/creating forgeries of the cards or stickers as these objects can be customized for each issuance.

### The “Access Management and Control” Module

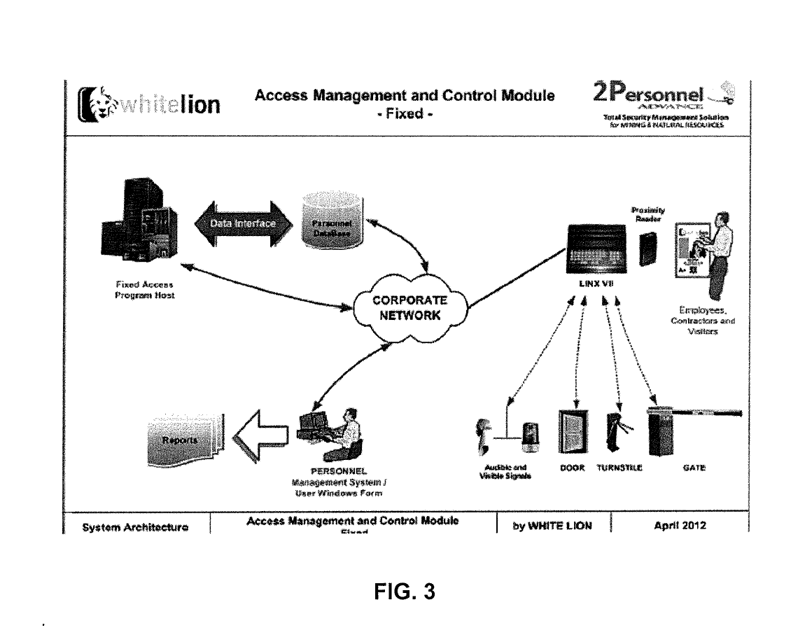

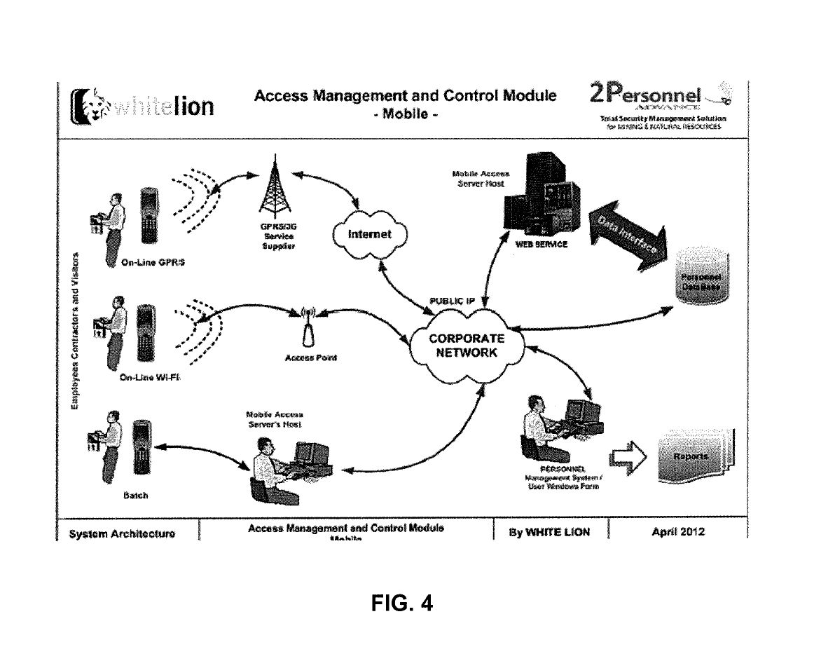

The “Access Control” module makes the most of electronic identification of persons having a direct and continuous relationship with the user-company, providing automated access control to the company's site or offices. This Module is used for managing access control process information through a computer system working on a PC supported by a database in the corporate network of the company. Control can be carried out via a fixed or portable terminal and may be on-line (with RF or GPRS communication) or off-line; fixed control can either be on-line or off-line. Generally, see FIGS. 3 and 4.

The Access Management and Control Module fulfills several discrete functions. It provides for the registration of physical areas as control points. Areas are hierarchical as are access permissions. The module allows for registering and easily configuring access control equipment and accepts different technologies to identify individual people such as but not limited to smart cards, biometric, RFID, barcodes portable devices, etc. It also assigns access permission for persons, be they permanent or temporary, or even hourly. The module also restricts access permissions to specified persons and provides for the creation of permission and restriction reason codes for access. The system allows recording indiscipline that, according to user requirements, can even be a restriction of access to user-company facilities. It allows for the issuance of reports of access attempts by range of dates, areas and departments etc. It allows for security and safety policies to be set in place to limit access control due to insurance expiration, expiration of medical examination, induction or training course expiration, contracts, etc. for people and vehicles. It allows for setting alarms when violations of security and safety policies are detected

Access Management and Control Module operation refers to the systems carrying out access control for physical locations and which activate electrical doors, electronic barriers as well as alarms and warnings. These systems validate the rules configured into the module, allowing or restricting people's access by opening or not opening doors etc. These systems operate with different equipment and activate different devices that can typically be classified as either “Fixed Access Control” or “Mobile/Portable Access Control.” Fixed Access Controls are those using terminals or equipment installed in facility foundations or walls and that need a data network and power to function. Mobile/Portable Access Controls are those using portable data terminals (PDTs) such as mobile devices mentioned at the outset, that do not need to be fixed or wall mounted and are operated by an individual. These systems are implemented in areas without power points or networks but where security staff control access.

The scope of the Access Management and Control Module is to provide pedestrian and vehicle access control. For portable devices, access control requires communication with the server by wireless or radio frequency technology (such as WiFi) and/or GPRS. By using these technologies, the information may be transferred and validated on-line and, should the communication be lost for any reason, the validation is performed by a batch that allows continuing operations while the failure is repaired. Should the portable devices communicate via cable, the information is validated and transferred by batches. Likewise, access control may also be conducted through fixed terminals of different data capturing technologies such as barcodes, proximity, smart cards, fingerprints, etc. These terminals are connected to electronic devices such as electrical doors, magnetic doors, revolving doors, vehicle barriers, etc. in such a way that they support access control actions. This is the kind of access control that this inventor calls “fixed.”

Both types of access, fixed or mobile, manage the validation process for each person by using access permission rules configured in the Access Control and Management module. These rules may be as simple as checking the validity of identification badges, medical examinations, environmental induction courses, insurance policy expiration dates, or as specific as special restrictions. When an employee, contractor or visitor uses his/her card or badge to attempt access, the system runs a validation of all the configured information in the management system and, if verified, the authorization is recognized, lifting the electronic barriers and granting access to the card or badge holder. For vehicle access control, the vehicle identification is read and the year of manufacture, insurance, technical inspection, etc. data is validated. If the access controlled vehicle data is valid, the system then first validates the driver's specific permissions (drivers license and assigned vehicle(s) as configured by the user) and then validates the passengers. The passenger validation process is conducted per the rules configured in the 2PERSONNEL® Access Management and Control module. The validation rules for access to areas within the site and other company offices and facilities are configured in 2PERSONNEL® management system as per the needs of the user-company and the scope detailed elsewhere in this disclosure. Lastly, when violations of the user-company's security and safety policy are detected alarms are activated and communicated via SMS or E-MAIL.

### The “Induction and Training Management and Control” Module

The “Induction and Training” Module manages attendance and compliance with the courses that payroll personnel and contractors must comply with according to the company's established policies and legal regulations (e.g., DS 055). Personnel may be restricted from entering their assigned work area if they are non-compliant with any of the courses. Management of the Module requires the assignation of proprietors, defined as administrators that can create modify and eliminate courses. Each proprietor can manage the courses of other proprietors. Those could include, for example, English courses, environment courses, driving courses, and the like. Users of the system may belong to different groups of proprietors. For example, User 1 may be the proprietor of English courses and driving courses and User 2 may be the proprietor of other courses. Managing third party teaching and training institutes requires handling the institutes data where courses are given, as well as managing worker profiles per required courses, such as those of supervisors, secretaries, administrators, etc. The system allows proprietors to classify certain posts according to the worker's profile; for example, a plant supervisor belongs in the “administrators” classification. For the purposes of managing courses, courses are created, modified or eliminated as per their proprietor. Coursework data includes banners or indicators of deadlines for completion, recurrence indicators, recurrence frequency (as of the date the course was assigned to an employee), expiration indicators for course compliance within a specific date range, restriction indicator for access, who is the course proprietor, among others. Furthermore, all driving courses labeled as such and driving courses, in particular, are automatically assigned to persons with a driver's license. Course assignment by worker profile functionality is created by the proprietor can be adjusted to each profile. For example, if a course must be retaken every 3 months, this can be modified to be every 5 months for the supervisor's profile. Courses are automatically assigned to workers according to their worker profile and are configured per hierarchy. Courses can also be manually assigned to anyone and the particulars of each course, such as the period of recurrence, can be tailored for a specific person. Automatic notification of courses is also created and each person is informed of the list of required courses. E-mail is sent with this information to the supervisor, worker or both. This process is carried out periodically and the supervisor's data is obtained from LDAP (Active Directory). The system indicates whether or not a person participates in the “Inductions and Training” Module. In the event all participate, this option is activated in General/Parameters so there is no need to ask individual persons about whether or not they completed the course. In this way, compliance is managed by the systems with colored flags (yellow, green, red) which are used to indicate user compliance, course status and if they passed or not. Where institutions provide courses, an Excel® file (Excel® is a registered mark of Microsoft®) listing attendance and grades for each person attending the course is sent to the user. These Excel® files can be loaded manually in the system or can be left in a specific repository and can be loaded massively using an automatic program that runs periodically. For massive loadings, an email is sent to the authorized person that includes a summary of the loaded data, including errors, if that be the case. Data loaded using Excel® files, modifies the status of the courses. This being the case, an approval notification is sent and the system is informed that the person has completed the course. This module also generates the following reports by individual person: Course Status (green, yellow, red), Completed Courses, Required Courses and Course Evaluation Results.

Operation of this Module requires that access be controlled by user validation. That is, persons who do not comply with the courses that are a requisite to enter the working site, according to the company's definition, may be denied access. This is validated in fixed access control as in portable access control.

### The “Time and Attendance Management and Control” Module

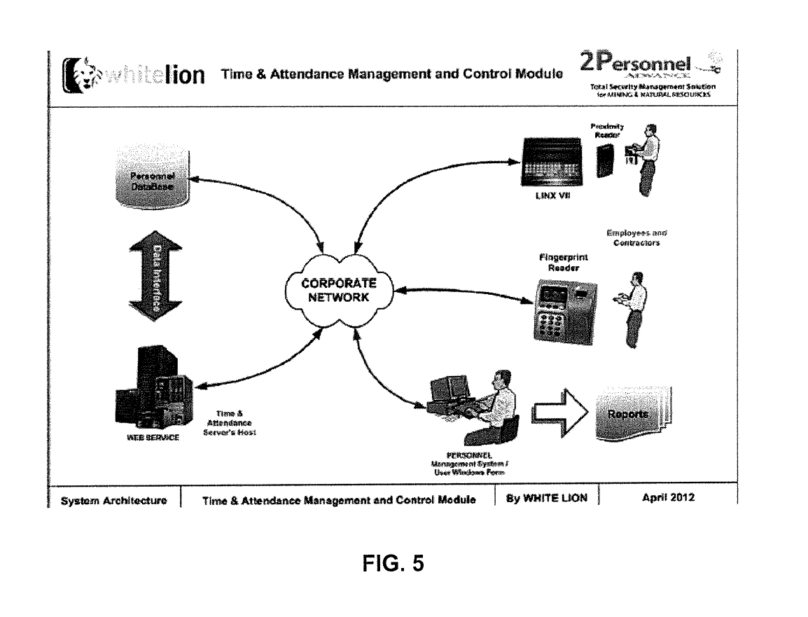

The electronic identification of personnel enables the control of attendance by means of a terminal or reader that can populate the card with place, date and hour of clocking wherever the user is using his/her badge. The location of these terminals is crucial for achieving the required level of control, not only to comply with the legal regulations but for safeguarding employee and the organization's general well-being. As with the Access Management and Control Module, this module's control may be performed on a mobile/portable device or through fixed wall readers or those placed on a fixed base platform. A fixed control is recommended by this inventor since the mobile/portable ones depend on one individual using it and this could give rise to controversies, therefore, the mobile/portable units should only be used for contingent situations. Generally, see FIG. 5.

This module manages attendance parameters such as hours, tolerance, per person and per groups or departments, etc. The attendance information of people changing groups or departments is kept in real time, respecting the parameters of each group or department that they were a part of. It also handles an “unlimited” number of schedules and hours. Schedules may be labor hours per week, such as 5×2, 6×1, etc. or hours per different shifts or periods, such as 21×7, 8×6, etc. Every working schedule is configured day-by-day for a 7-day week, which means that there is the possibility of different clocking-in and clocking-out on different days in a daily shift. The user-company may determine if the individual starts the shift on a previous day or on the same day. Every shift is configured day-per-day every working day, which means that there is a possibility of different clock-in and clock-out hours for different days in a single schedule. The user-company may determine if the individual starts the shift on the previous day or on the same day. People may be assigned different hours on rotating schedules. Controls may be set to track, the minutes an individual employee is out of the office, overtime in minutes before the scheduled clock-in time, overtime in minutes after clock-out time, lunch minutes, and overtime in minutes for non-working days. There is the possibility of creating an “unlimited” number of justifications (reason codes) for employee absences, tardiness, out of office on a mission, etc. which may be allocated to individuals per periods of time, be it on a full-day basis or per minutes. Mass justifications may also be created. Besides the core classification of people (groups or departments), there are new classifications that can be created to order reports with said new classifications, these are called “additional data” within the system. Only those who are in positions of accountability and responsibility have the corresponding authorizations to make manual entry and clocking corrections. Each user can be assigned to one or more groups to manage their attendance. This means that part of the administration and management of the attendance control may be decentralized and given to the supervisors of the different areas and only these individuals are able to manage the personnel that report directly to them. The system standard reports provide complete information on attendance control such as tardiness, absences, overtime and breaks, all of which are grouped by en employee's core classification or by other classification criteria (additional data), within the time periods determined by the user. The system of the present invention provides consolidated information in ASCII specific format and/or in SQL tables. Logged hours are recorded according to the local legal regulations—such as, hours 25%, hours 35% and hours 100% per employee. Likewise, the system provides tardiness in minutes and absence in days per each employee in the same formats. This information is used as an interface to deliver the information to other systems.

Further, absenteeism and tardiness may be reported as statistics by the user-company. Web interfaces allow for reporting by groups and to account for certain features defined by the user. On the other hand, those same reports may be obtained individually instead of by groups, such as:
Absence Report
Tardiness Report (Delays at the beginning of the shift or schedule)
Leaving before time Report
Overtime Report (before clock in time and after hours)
Clocking Report
Justifications Report
Clock-in and clock-out Report.
Worked Hours Report
Absence statistical graphs Report
Justified absence statistical graphs Report
Labor Ministry Official Report

Absenteeism and tardiness may be reported as statistics. The schedules are assigned through Web interfaces to decentralize the process. Likewise, the justifications to be recorded by supervisors having people in their groups incurring in absences, are assigned through web interfaces. Only those who are responsible and accountable have the corresponding authorizations to make manual entry and clocking corrections.

Operation of the “Time and Attendance Management and Control” Module can be via mobile/portable control or fixed control; mobile control can be on-line (with WiFi or GPRS/EDGE communication) or off-line; and fixed control can either be on-line or off-line. Different technologies may be used for the purposes of “capturing” data and include but not limited to, proximity, barcodes, biometric, smart cards, among others. The data capture technology used in the 2PERSONNEL® system is transparent to the software, meaning that 2PERSONNEL® accepts any data capture technology available on the market. The software may process “n” number of clockings by pairs, which means that the user-company may have 6 clockings in one day that would correspond to clocking-in and out of the company, clocking-out to lunch and clocking-in from lunch, and an additional one where the individual had to leave the premises for a personal external activity or by commission of the company. The two remaining clockings would correspond to this movement and would be registering the time during which the individual was out of the office. The clocking places may be located wherever the company needs them or decides fit, as the clockings may be centralized in a unique database. Lastly, clocking may be performed by keyboard via web if needed.

### The “Mess Hall Management and Control” Module

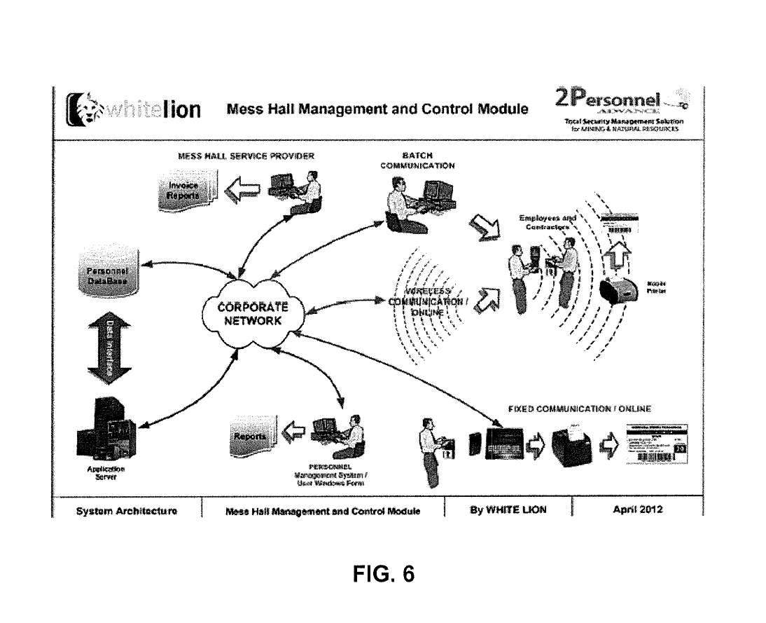

With readers or terminals installed in the user-company's mess halls the “Mess Hall Management and Control” Module performs date and hour registration of ID card allowing for electronic identification of personnel. As with the other access controls, this process is carried out by either mobile/portable devices or with wall mounted or base fixed card/badge readers, depending on mess hall infrastructure. Generally, see FIG. 6.

The Mess Hall Management and Control Module provides a number of functionalities that identifies all locations where food services are provided, and allows for the configuration of different food services offered by the user-company. These food services may range from the commonly used terms of breakfast, lunch and dinner, to user-defined services that may be described as coffee breaks. The type of services per mess hall and hours are configured accordingly for each mess hall. Not all mess halls necessarily provide the same services or during the same hours. Likewise, service prices may vary depending on the mess hall. The present invention's system allows for a wide range of configurations including the configuration of services within the same schedule for one mess hall by calling it special services that are controlled through mobile/portable terminals. The registry of access to mess hall is configured on a per person permit basis and also provides for the configuration of a list of people who are allowed to access specific services in appointed mess halls. The system provides each company the ability to configure permissions mess hall access permits granting employees of a given company certain specific services in given mess halls. Once different cost centers are imported into the system from the user-company's ERP, per employee consumption charges are registered to different these cost. Appointing cost centers to individuals, employees or contractors allows them to charge mess hall consumption to their respective cost center. The cost of mess hall services may be expressed in more than one currency, allowing for conversion rates in management reports. Manual registration of consumption is also possible should an unforeseen event prevent terminals from working properly when registering access to mess halls. Specifically, there would be a user interface that would allow numbers to be entered manually. Lastly, mess hall the system generates consumption reports, individual consumption reports, reports per company, per cost centers and per periods of time.

The Mess Hall Management and Control Module encompasses the systems validating or checking that someone is authorized to use the mess hall, be this via mobile/portable or fixed control. Mobile/portable control can be on-line (with RF or GPRS communication) or off-line; and fixed control can either be on-line or off-line. These systems work with different equipment and activate different devices and are typically classified in two ways: fixed mess hall control and mobile/portable mess hall control. The fixed mess hall control uses terminals or equipment built into facility foundations or walls and uses a data network and power. The mobile mess hall control uses portable data terminal (PDTs), does not need to be fixed and is used by an individual in a mobile/portable manner. These portable devices are used on mine sites for mobile mess halls.

The “mobile” mess hall control communication system can use RF technology or GPRS, or simply a cable. The latter allows for batched information transfer to and from the portable devices (both ways). The two first cases may send the information and validate it on-line. As one of the controls of this Module is focused on preventing someone from using the service more than once, it is recommended that control by RFID and/or GPRS technology devices be used. A printer is used additionally to print tickets or vouchers as proof of consumption. The “fixed” mess hall system controls the installed terminals and includes printers to issue vouchers or tickets. Sound or light signals may be added to confirm the card reading. Consumption Validation is provided by company badge validity, the company-configured permissions and service management, that also includes double-consumption permissions per person.

### The “Camp Management and Control” Module

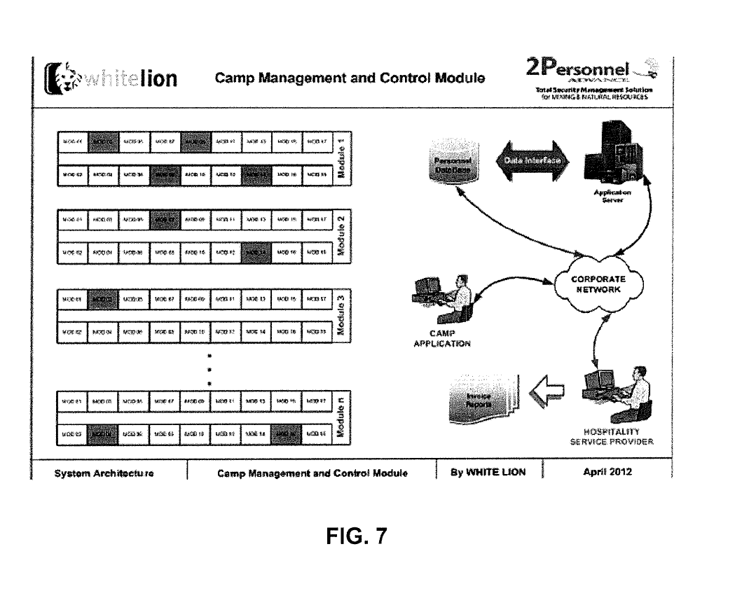

The “Camp Management and Control” Module provides for accommodation and housekeeping management. That is, the module manages room, availability, number of overnight stays and staff and/or third-party housekeeping service providers. Generally, see FIG. 7. This Module manages information such as configuring the site as a set of zones, hotels, etc. that can be divided into modules or facilities which, in turn, are divided into rooms. This layout may simulate camps, modules within the camps, and rooms within the modules. The rooms may have beds (one or more beds), which is a feature applicable to the hotels themselves. Cleaning tasks may be configured per room. The user-company may create different tasks and specify the average times to perform each one. Further, tasks programmed for each room may be assigned for a certain period of time or indefinitely, while allowing for some slack on the tasks performance. The operator quickly and effectively controls tasks, receiving status on each one of them. Tasks have different status that change automatically if the performance of the task has stopped, is complete or if the task is cancelled. The tasks completion is registered via PDT. To do so, a zone supervisor approves the performance by reading the ID badge and entering a password. Every task can have a cost allocation for the purposes of invoicing and these costs may be stated in more than one currency. Lastly, accommodation tasks include check-in and check-out, as well as reservations.

Further, check-in may be performed with or without a reservation, validating bed availability. Check-in, check-out and reservations are performed by bed, meaning that every room may have more than one occupant. It allows for relocation of guests rooms when availability issues arise and allows for extensions of stays. Reservations and expirations are managed within the system as are housekeeping tasks. Consolidated and detailed reports to invoice by company and by cost center can be generated.

The Camp Management and Control Module is for recording task fulfillment and is conducted by individuals using portable terminals. Staff in charge of completing tasks must record supervisor approval via a PDT when tasks are finished. The PDT has a program that locates the task, identifies who performed it, and records the date and hour of completion as well. There is an approval option in this program that reads the ID badge and requires a password from the supervisor. This approval changes the status of the tasks to “Executed.” For access control to enter into rooms, the system can use the company-issued ID (badge). All hotel management, is performed through the Camp Management and Control Module.

### The “Visits Management and Control” Module

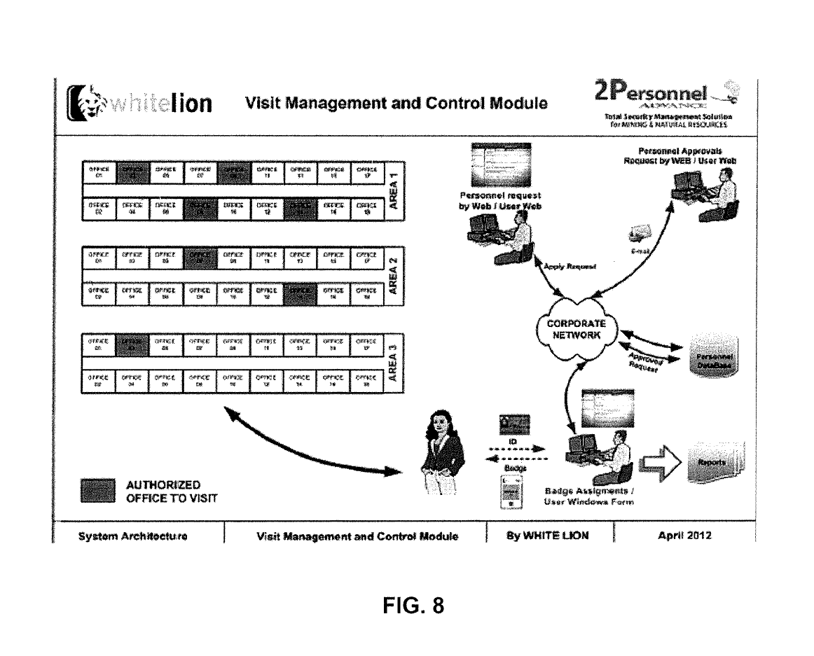

The “Visits Control” Module refers to the management of visitor access requests. A workflow of request approvals is kept on a web system, that manages visitors with the same access control system that is used for employees, issuing each one of the visitors a temporary card containing the same technical features as those used by the user-company's employees. Generally, see FIG. 8.

This Module requires that the visitor system (available via the web) record one request at a time. A visitor's registry may list one or more people who have the same access conditions to different areas and may or may not include access to dinning halls or lodging arrangements. Should there be a subgroup of people within a group eating in different areas and having access to different areas, two requests must be submitted that detail access criteria for each group. The minimum data that is required is the reason for the visit, the visitors' company name, visit start and end date and start and end time. Hierarchy levels determine visit approval. The system allows for a customized approval policy that may be subject to zone approval, department approval, and/or approval by a specific person for each policy, as may be desired or required. Provisions can be configured in the system in the event of an emergency so that an authorized person can directly approve the request. Requests are approved (or denied) via e-mail or other suitable form of written communication. Requests for access to specific areas are also processed in the system and can be approved or denied. A visitor management and operations report can also be generated as needed.

The operation of this Module uses access control infrastructure and the same types of control, (fixed and mobile/portable control). Visitor management flow is as follows: anyone having access to the intranet, specifically to a “Visitors Requests” web page, may file a request to receive visitors. Several steps are required request a visitor. This process involves filling out a form, specifying the name(s) of the visitor(s), the areas where they circulate (access control), if they eat on site (mess hall control), if they sleep on site (camp management) and the date and time of visit.

Once the form is complete, it is sent to those responsible for approving visitor requests. This request may require more than one approval. When visitors reach the gates, the control post or the reception desk, they will identify themselves and/or the company sponsoring the visit. The control staff searches for the approved request in the system and exchange the visitor's identification card for a personal ID document. The visitor has access to the user-company's facilities, or some portion of it, and the access control is similar to the access control for facilities and mess halls mentioned elsewhere in this disclosure. Before leaving the premises, the visitor hands the identification card back to the control staff and receives their personal ID document. The visit information is recorded in the document return system.

### The “Fuel Management and Control” Module

The “Fuel Management and Control” Module helps to control and register fuel dispatch to concessionaire companies that distribute this product to mining companies. The module uses personnel's identification to record consumption using portable data terminals (PDTs), reading the identification card of users and registering the data of the operations in the PDT memory or directly in a host if PDTs wireless coverage is available.

Management of fuel involves the configuring and consulting module of fuel dispatch operations. It has at least the following functions: registering and updating equipment conducted by PDT registration and controls of fuel dispatches; registering and updating tanks, carried out by registering the different tanks receiving or dispatching fuel. Here, the type of fuel that the tank contains must be indicated and comptometers used to measure the “incoming” or “outgoing” fuel. Further, in this sub-module, the barcode is printed with the comptometers code that are used to identify each individual comptometer; registering and updating accounts, accomplished by registering the user-company's data who is authorized for receiving fuel. The registered data includes the code, name, company's name, RUC (tax ID number), flag or printed voucher code that authorizes a person and/or company vehicle to receive fuel. Additionally, the system registers a detailed listing of authorizations to vehicles or persons related to the company. The 2PERSONNEL® system contains an updated and current listing of personnel in charge of executing dispatch operations using portable terminals. The Drivers' Registry contains an updated and current listing of drivers who can request fuel dispatch. This listing can be obtained from the identification module, where driver data, such as name, type of collaborator (employee, contractor of visitor), card code, etc. is stored. Communication with a PDT is accomplished by communication interface between the PC and the PDT and loads and unloads the operation data captured by the PDT. Tallying of the fuel received (IN) and/or dispatched (OUT) per work shift and per worker is calculated by the comptometers. Consumption and tally totals are registered by the system and reports can be prepared either for per tank consumption, type of fuel, account, voucher number, tally, comptometers and other criteria. Results of these reports can be downloaded into an Excel® file as well. Lastly, printed vouchers are used to identify fuel dispatch information. This option is used as a contingency in the event the information cannot be downloaded from a portable terminal.

Operation of the “Fuel Management and Control” Module involves employee badge, comptometer, odometer and vehicle identification when and where fuel is dispatched. That is, all fuel dispatchers are registered in the 2PERSONNEL® system. Upon reading the person's and vehicle's badges, a validated authorization of the comptometer's unit number, fuel type, quantity, vehicle odometer, temperature and altitude at time of fueling will take place. The module also records and uses this data for statistical purposes and prepares summary statistical reports of dispatches per fuel type, per vehicle, per company among others. The module also provides detailed information of each of the configurations including the PDT loading and unloading. Furthermore, the module can also update timekeeping and application installer information.

### The “Transport Management and Control” Module

The “Transport Control” Module allows for managing and measuring time between the different control points for all transportation units including but not limited to light vehicles, station wagons, passenger buses and freight transports in their various forms. This module also manages driver and vehicle compliance with all required validations and permits.

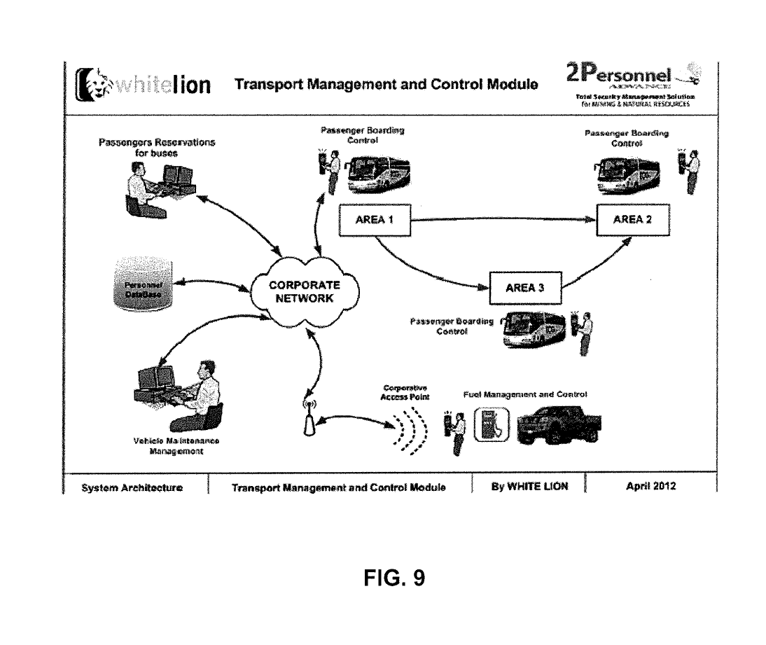

The Module also allows user to configure different types of vehicle classifications and provides a vehicle registry for those vehicles with access area restrictions. Access restrictions are managed by way of a printed vehicle label. Additionally, the module also provides for managing cargo by assigning cargo to a transport vehicle. All haul times can be tracked and managed from start to end (including return trips) via a screen that registers control points, distances between these, the average speed for each type of vehicle and load. The system allows the use of PDTs for reading vehicle codes and for assigning cargo types to each and also determines the initial and destination control points. With this information, the system validates the average speed with which the cargo should be transported and thereby determines an estimate of the total time between one point and the other. The system provides for the configuration of a table containing user-defined delay reason codes for the purpose of classifying and managing this data so that it is reflected in the vehicle's management reports. See FIG. 9, generally.

### The “Personal Protective Equipment” Management and Control Module

The “Personal Protective Equipment” (PPE) Management and Control Module (or “PPE Module”) is part of the present invention that allows a user-company to consign and track corporate PPE assets to specific employees, suppliers, contractors, visitors, guests and other authorized persons (collectively, “personnel”), as well as to control, manage and validate the expiration period of PPE, as well as the entry and exit of PPE at any job site and/or industrial and mining operations.

The scope of the PPE Module allows for PPE information management including:
PPE Classification
Registration and Validation of the Useful Life of PPE based on job function or standard expiration of the PPE
Configuring the maximum number of allowable incidents for type of PPE
PPE requirements per application
Incident logging for each PPE and
Assigning volume management prerequisites for PPE restocking and delivery.

The scope of this module also allows consigning and assigning of PPE to certain personnel, either by permanent assignment or temporary consignment. Permanent assignment includes:
Defining the PPE required by job function
Recording delivery date per location of the receiving individual
Digitalizing the PPE receipt and
Printing the PPE receipt.

Temporary consignment includes:
Consignment by location
Recording delivery date
Digitalizing the PPE receipt and
Printing the PPE receipt.

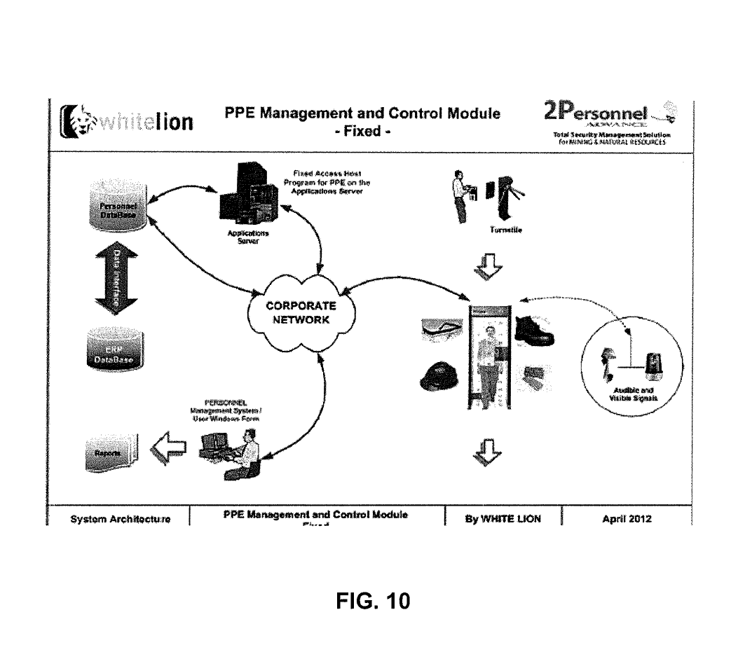

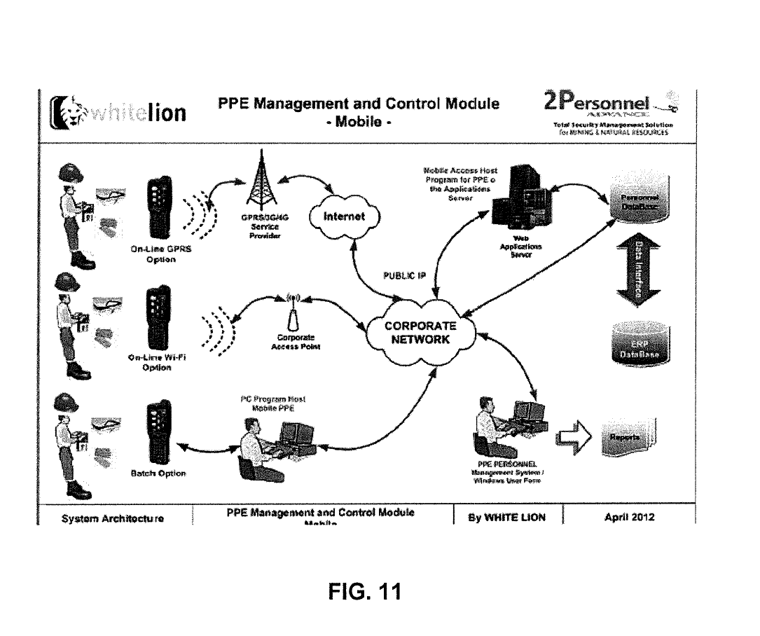

Similarly, the use and validity of PPE can be managed in one of two ways. One way is by “fixed” control. See FIG. 10. The other is by “mobile” or “portable” control. See FIG. 11. Fixed control comprises using equipment installed within the adequate infrastructure of a given job site or work location so that the required equipment can function correctly. For this to take place, RFID technology is used that allows for simultaneous reading of PPE through an RFID doorway/portal/reader and this will validate in accordance with the following methodology:
The person's identification is validated as are the PPE required for the job-site application and or work area in question;
The presence of the required PPE assigned to the individual is then validated per the work area in question;
The PPE useful life is validated and expiration dates checked to ensure that the PPE has not expired and does not expire while the person assigned the PPE is working (pre-expiration warning);
If the above-mentioned are valid, the systems will send a signal or a message of entry approval, one way will be by an electronically-controlled turnstile that opens giving the individual access to the work area;
If the above-mentioned are not valid, the systems will send a signal or a message of entry denied, one way will be by an electronically-controlled turnstile does not open, triggering an alarm per the invalid PPE (Dash Board Monitoring); and
The incident is recorded.

On the other hand, mobile/portable control involves control personnel using handheld devices/readers. In this case, the handheld device reads the individual's identification card and the scanned information appears on the screen of the handheld device listing the required PPE that must be in use by an employee before that employee gains access to the work area. Next, the following validation process begins:
Once individual's identification credentials are validated and a list of the required PPE is generated for the specific work area in question. The security personnel at the entry point conducts a visual inspection and validates, reading the RFID labels with the hand held device, that the individual requesting entry is carrying, wearing and/or all the required PPE per the work area as well as the PPE listed on the hand-held device;
The PPE useful life is validated via an RFID scan;
If all equipment is present and valid, the security personnel taps the green button on the handheld screen and gives the individual entry. There could also be an electronically-controlled turnstile, or any other technology, in place, that would open to provide access to the work area once the green button is pressed;
In the event the required PPE is not all present or there are expired PPE or both, the red button appears on the hand-held screen indicating that the PPE is missing and/or expired; and
The incident is registered on the handheld device, which is also capable of registering PPE incidents.

In accordance with the present invention, a number of reports or messages can be generated by the user-company using the PPE Module. They include:
List of assigned PPE, by company, department and by date
E-mail correspondence on PPE about to expire and for those that have expired
SMS correspondence on PPE about to expire and for those that have expired
E-mail correspondence on PPE stock and re-ordering levels to the purchasing department
Historical records of PPEs assigned to each individual and a registry of the signed receipt
PPE incident list and
PPE events with restrictions by date, company and area.

Lastly, the system configuration for the PPE Module are preferably as follows:
Oracle or SQL Client/Server Database for the PPE Management Module
Visual Studio .NET 2005 development tool
Use of Hand-held devices for the modules using Windows Mobile 6.5 or higher
RFID Technology for the identification of People and PPE and
WiFi, GPRS and Ethernet Communication

The foregoing details a new and useful multi-industry technological solution for managing people, assets and services using automatic identification technology with fixed and mobile/portable equipment herein presented in accordance with the present invention.

The details of the invention having been disclosed in accordance with the foregoing, I claim:

1. A computer implemented method for consigning and tracking a PPE asset that is provided to employees, contractors and visitors for use at industrial or mining operation job site, the method comprising the steps of:
classifying the PPE asset;
registering the PPE asset;
validating the useful life of the PPE asset;
configuring the maximum number of allowable incidents for the PPE asset; and
configuring an incident log involving PPE assets.

2. The method of claim 1 further comprising the steps of:
providing a plurality of PPE assets; and
assigning volume management prerequisites to the plurality of PPE assets.

3. The method of claim 1 further comprising the steps of controlling, managing and validating an expiration period of the PPE asset.

4. The method of claim 1 further comprising the steps of controlling, managing and validating the entry and exit of the PPE asset at the job site of the industrial or mining operation.

5. The method claim 1 further comprising the step of consigning the PPE asset to personnel on a permanent or a temporary basis.

6. The method of claim 5, wherein the consignment of the PPE asset on a permanent basis comprises assigning the PPE asset to personnel and further comprises the steps of:
defining the PPE asset as a required asset of a job function;
recording the delivery date of the PPE asset to assigned personnel;
digitalizing a receipt for the delivery and acceptance of the PPE asset; and
printing the receipt.

7. The method of claim 5 wherein the consignment of the PPE asset to the personnel on a temporary basis comprises the steps of:
consigning the PPE asset by job site location at the industrial or mining operation;
recording the delivery date of the PPE asset to the assigned personnel;
digitalizing a receipt for the delivery and acceptance of the PPE asset; and
printing the receipt.

8. The method of claim 1 further comprising the step of generating reports and/or communications with respect to the consignment of the PPE asset, such reports and/or communications including one or more from a group consisting of:
a list of PPE assets assigned by company;
a list of PPE assets assigned by department;
a list of PPE assets assigned by date;
electronic messages transmitted via e-mail for PPE assets that are about to expire;
electronic messages transmitted via e-mail for PPE assets that have expired;
electronic messages transmitted via short message service (SMS) for PPE assets that are about to expire;
electronic messages transmitted via short message service (SMS) for PPE assets that have expired;
electronic messages on PPE asset stock and re-ordering levels to a purchasing department;
historical records of PPE assets assigned to personnel and a registry of the signed receipts;
incident lists for PPE assets; and
lists of PPE asset events with restrictions by date, company and area.

9. The method of claim 1 wherein the use and validity of the PPE assets is managed by radio frequency identification (RFID) technology via fixed or mobile control methodology.

10. The method of claim 1 further comprising the step of providing modular functionality in one or more from a group consisting of general management and administration, candidate management and control, identification management and control, employee and vehicle access management and control, induction and training management and control, time and attendance management and control module, mess hall management and control, camp management and control, visits management and control, insurance management and control, fuel management and control and transport management and control.

11. A computer program product for consigning and tracking a PPE asset, the asset being provided to personnel for use at the job site of an industrial or mining operation, the computer program product being embodied in a non-transitory computer readable medium comprising computer instructions for:
classifying the PPE asset;
registering the PPE asset;
validating the useful life of the PPE asset;
configuring the maximum number of allowable incidents for the PPE asset; and
configuring an incident log for the PPE asset.

12. The computer program product of claim 11 further comprising computer instructions for:
providing a plurality of PPE assets; and
assigning volume management prerequisites to the plurality of PPE assets.

13. The computer program product of claim 11 further comprising computer instructions for controlling, managing and validating an expiration period of the PPE asset.

14. The computer program product of claim 11 further comprising computer instructions for controlling, managing and validating the entry and exit of the PPE asset at the job site of the industrial or mining operation.

15. The computer program product of claim 11 wherein computer instructions are provided for the consignment of the PPE asset to personnel on a permanent basis or on a temporary basis.

16. The computer program product of claim 15 wherein the computer instructions for the consignment of the PPE asset on a permanent basis comprises an assignment of the PPE asset to the personnel and further comprises computer instructions for defining the PPE asset as a required asset of a job function; recording the delivery date of the PPE asset to the personnel; digitalizing a receipt for the delivery and acceptance of the PPE asset; and printing the receipt.

17. The computer program product of claim 15 wherein the computer instructions for the consignment of the PPE asset to the personnel on a temporary basis comprises computer instructions for consigning the PPE asset by location of the job site of the industrial or mining operation; recording the delivery date of the PPE asset to the personnel; digitalizing a receipt for the delivery and acceptance of the PPE asset; and printing the receipt.

18. The computer program product of claim 11 further comprising computer instructions for generating reports and/or communications relating to the consignment of the PPE asset, such reports and/or communications including one or more from a group consisting of:
a list of PPE assets assigned by company;
a list of PPE assets assigned by department;
a list of PPE assets assigned by date;
electronic messages transmitted via e-mail for PPE assets that are about to expire;
electronic messages transmitted via e-mail for PPE assets that have expired;
electronic messages transmitted via short message service for PPE assets that are about to expire;
electronic messages transmitted via short message service for PPE assets that have expired;
electronic messages on PPE asset stock and re-ordering levels to a purchasing department;
historical records of PPE assets assigned to personnel and a registry of the signed receipts;
incident lists for PPE assets; and
lists of PPE asset events with restrictions by date, company and area.

19. The computer program product of claim 11 wherein the computer instructions for the use and validity of the PPE assets are managed by radio frequency identification (RFID) technology via fixed or mobile/portable control methodology.

20. The computer program product of claim 11 further comprising computer instructions for providing one or more functionalities from a group consisting of general management and administration, candidate management and control, identification management and control, employee and vehicle access management and control, induction and training management and control, time and attendance management and control module, mess hall management and control, camp management and control, visits management and control, insurance management and control, fuel management and control and transport management and control.
